(19) United States
(12) Patent Application Publication
(10) Pub. No.: US 2010/0135470 A1
(43) Pub. Date: Jun. 3, 2010

(54) CALL IMPACT DETERMINATION TOOL

(75) Inventor: David BISHOP, Woodstock, GA (US)

Correspondence Address: AT & T LEGAL DEPARTMENT - GB;ATTN: PATENT DOCKETING, ROOM 2A- 207, ONE AT & T WAY, BEDMINSTER, NJ, 07921, US

(73) Assignee: AT&T INTELLECTUAL PROPERTY I, L.P., Reno, NV (US)

(21) Appl. No.: 12/325,473

(22) Filed: Dec. 1, 2008

(51) Int. Cl. H04M 3/22; H04W 24/00

(52) U.S. Cl. 379/32.01; 455/423

(57) ABSTRACT

A method for monitoring call dispositions for a mass calling application at a voice over internet protocol platform includes receiving calls at the voice over internet protocol platform. The method includes processing each of the calls according to application-specific requirements for each call. The method includes aggregating error information for each of the calls in categories based on call dispositions. The method also includes displaying the aggregated error information categorized based on call dispositions for each of the applications that provide services for the calls for which error information is aggregated.

### BACKGROUND

1. Field of the Disclosure

The present disclosure relates to mass calling applications. More particularly, the present disclosure relates to monitoring impact of server failures in a voice over internet protocol platform that serves mass calling applications.

2. Background Information

In a mass calling system, call processing commences with a caller at a public switched telephone network location dialing a telephone number. A local exchange carrier queries a database to determine which telecommunications carrier should handle the call. The database returns a carrier identification code and a routing number. In some cases, the routing number is a dialed toll-free number. In these cases, the local exchange carrier routes the call to a switch. The switch provides telephone messages to thousands of callers that access the switch. For example, a mass calling application for which a switch may be employed includes a tele-voting application.

### BRIEF DESCRIPTION OF THE DRAWINGS

FIG. 1 shows an exemplary general computer system that includes a set of instructions for monitoring impact of outages in a voice over internet protocol platform;

FIG. 2A illustrates a system diagram of the hardware architecture for a call impact determination tool, according to an aspect of the present disclosure;

FIG. 2B illustrates an exemplary call log for a first server in the voice over internet protocol platform;

FIG. 2C illustrates an exemplary call log for a second server in the voice over internet protocol platform;

FIG. 2D illustrates an exemplary call log for a third server in the voice over internet protocol platform;

FIG. 3 illustrates a process flow diagram for determining and displaying call disposition of calls in a voice over internet protocol platform, according to an aspect of the present disclosure;

FIG. 4A illustrates an exemplary display of call disposition in a voice over internet protocol platform, according to an aspect of the present disclosure; and

FIG. 4B, illustrates an exemplary display of call disposition by call number and error code in a voice over internet protocol platform, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below. According to one aspect of the present disclosure, a method for monitoring call dispositions for a mass calling application at a voice over internet protocol platform includes receiving calls at the voice over internet protocol platform. The method includes processing each of the calls according to application-specific requirements for each call. The method includes aggregating error information for each of the calls in categories based on call dispositions. The method includes displaying the aggregated error information categorized based on call dispositions for each of the applications that provide services for the calls for which error information is aggregated.

According to another aspect of the present disclosure, a display of the aggregated error information is updated in real-time.

According to yet another aspect of the present disclosure, the call dispositions include successful completion, dropped call, failed call and failed transferred call.

According to still another aspect of the present disclosure, the error information for each of the calls is obtained from call logs maintained by each of the servers at predetermined intervals.

According to one aspect of the present disclosure, error information for each of the calls is obtained from a call log maintained by a server when the server raises an alarm.

According to another aspect of the present disclosure, the method includes determining error information for each of the calls based on codes from call log entries corresponding to each of the calls.

According to yet another aspect of the present disclosure, a number of calls offered and a percentage success rate of offered calls is displayed according to each of the applications.

According to still another aspect of the present disclosure, parameters for a call log entry stored in the call log comprise call disposition, exit type, destination name and destination number.

According to one aspect of the present disclosure, display information for the aggregated error information is provided to a device.

According to another aspect of the present disclosure, the device is a mobile device.

According to yet another aspect of the present disclosure, a notification is sent to the device via at least one of text message, webpage, email, automated phone call and facsimile.

According to still another aspect of the present disclosure, the notification includes information associated with the aggregated error information.

According to one aspect of the present disclosure, a system for monitoring call disposition for a mass calling operation at a voice over internet protocol platform includes at least one server operable to receive calls. The system includes at least one processor operable to process each of the calls according to application-specific requirements for each call. The system includes an aggregator operable to aggregate error information for each of the calls in categories based on call dispositions. The system includes a second processor operable to display the aggregated error information categorized based on call dispositions for each of the applications that provide services for the calls for which error information is aggregated.

According to another aspect of the present disclosure, the applications are serviced by the voice over internet protocol platform.

According to one aspect of the present disclosure, a tangible computer readable medium storing a computer program, recorded on the computer readable medium, for monitoring call disposition in a mass calling operation at a voice over internet protocol platform includes a receiving code, recorded on the tangible computer readable medium, executable to receive calls at the voice over internet protocol platform. The tangible computer readable medium includes a first processing code, recorded on the tangible computer readable medium, executable to process each of the calls according to application-specific requirements for each call. The tangible computer readable medium includes an aggregating code, recorded on the tangible computer readable medium, executable to aggregate error information for each of the calls in categories based on call dispositions. The tangible computer readable medium includes a displaying code, recorded on the tangible computer readable medium, executable to display the aggregated error information categorized based on call dispositions for each of the applications that provide services for the calls for which error information is aggregated.

According to another aspect of the present disclosure, a number of calls failing due to a predetermined error code is displayed along with call dispositions for the calls.

According to yet another aspect of the present disclosure, the predetermined error code corresponds to a predetermined error condition.

According to still another aspect of the present disclosure, a predetermined error condition includes at least one of: a blocked call, an unanswered call, a dropped call, a platform redirector error, a platform application error, a malformed call request, a platform component failure and a caller hanging up.

According to one aspect of the present disclosure, a platform redirector error includes at least one of: failure to recognize an incoming dialed number identification service, inability to find an application uniform resource locator and a timeout during an application fetch from a content server.

According to another aspect of the present disclosure, a platform application error includes at least one of: inability to fetch audio files due to a provisioning error, inability to fetch audio files due to a network file system resource being unavailable, inability to retrieve an announcement identification associated with a dialed number identification service, and inability to retrieve an application-specific grammar.

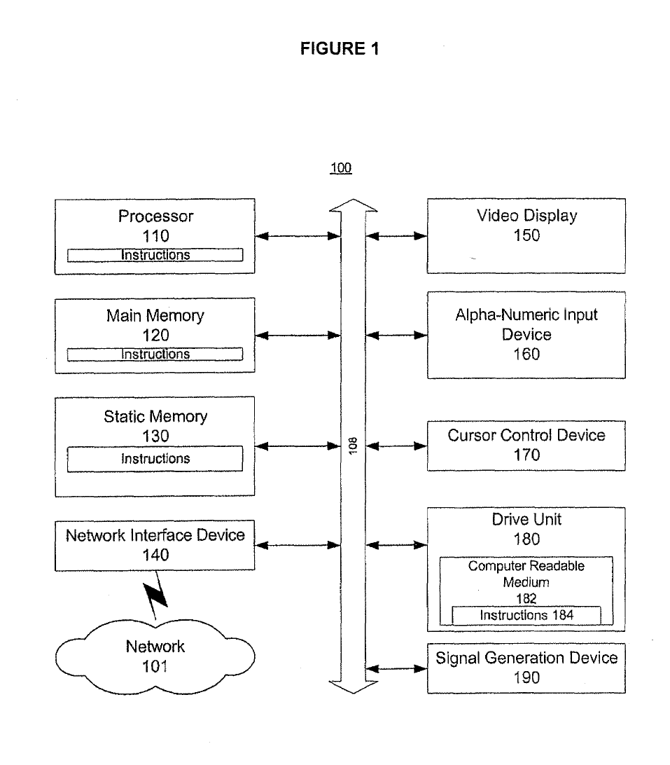

FIG. 1 is an illustrative embodiment of a general computer system, on which a method to provide a call impact determination tool can be implemented, which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, a global positioning satellite (GPS) device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. A computer-readable medium 182 is a tangible article of manufacture, from which sets of instructions 184 can be read. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

There are several switches that traditionally handle mass calling operations and include a combination of hardware and software that is now unsupported. A voice over internet protocol platform presents an option for servicing mass calling applications in place of unsupported switches. In order to remove mass calling applications from traditional and unsupported switching devices, mass calling applications are handled by a voice over internet protocol platform according to the present disclosure. When a server in the voice over internet protocol platform that receives and processes calls becomes inoperative, callers experience an impact. Accordingly, operations administration and maintenance tools are used to monitor, detect, and diagnose issues with voice over internet protocol ports. These operations administration and maintenance tools run on a data collections gateway. In this manner, operations administration and maintenance tools allow an administrator to determine an impact of server outages and service failures to callers.

Legacy long-distance services are replicated in a voice over internet protocol platform environment by supporting the de-loading of switches and edge switches. Accordingly, a replacement solution for the toll-improved service announcements and information collection (ISAIC) platform is provided. The ISAIC platform is a component of a time division multiplex network and supports interactive voice response functionality for playing announcements and collecting input from callers. These capabilities are used to support customers of various legacy long-distance services, including, but not limited to positive call processing, a software defined network, an AT&T network connection, toll-free services, and custom mass calling event applications. The ISAIC platform also provides announcement provisioning and management capabilities. These announcement provisioning and management capabilities enable the advanced features services center to provision and manage announcements and ancillary data associated with the announcements (e.g. announcement text, announcement identifier) on behalf of long-distance customers. Announcement provisioning capabilities also enable customers to call an “8yy” number to record announcements in real-time. The ISAIC platform is transparent to long-distance customers.

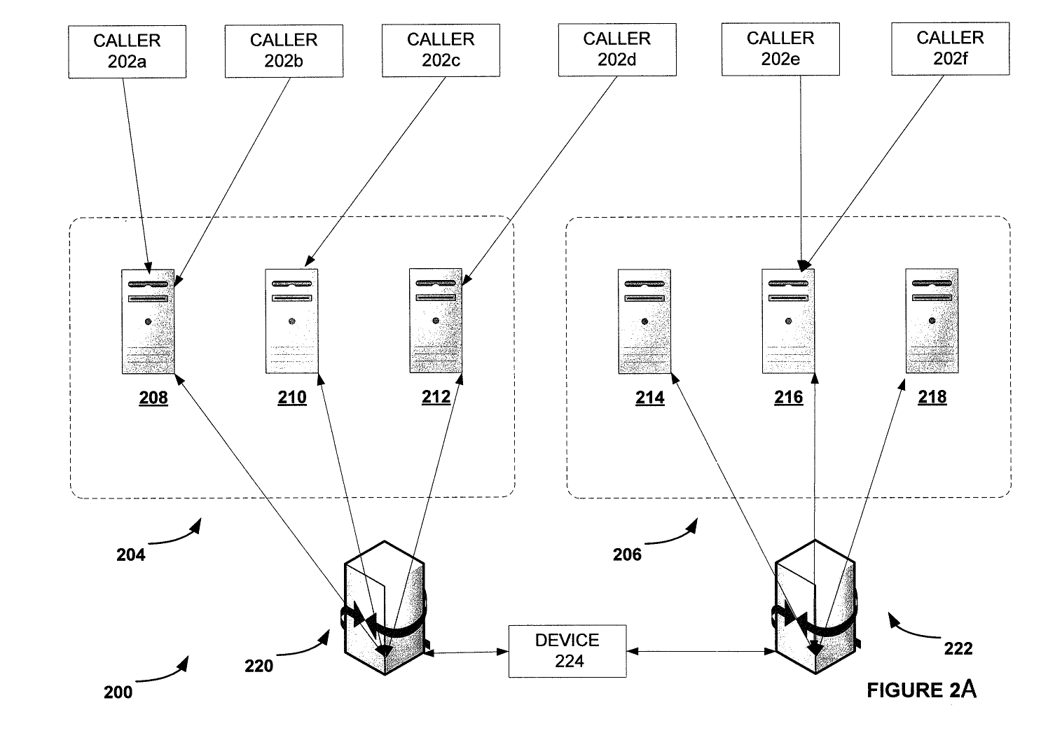

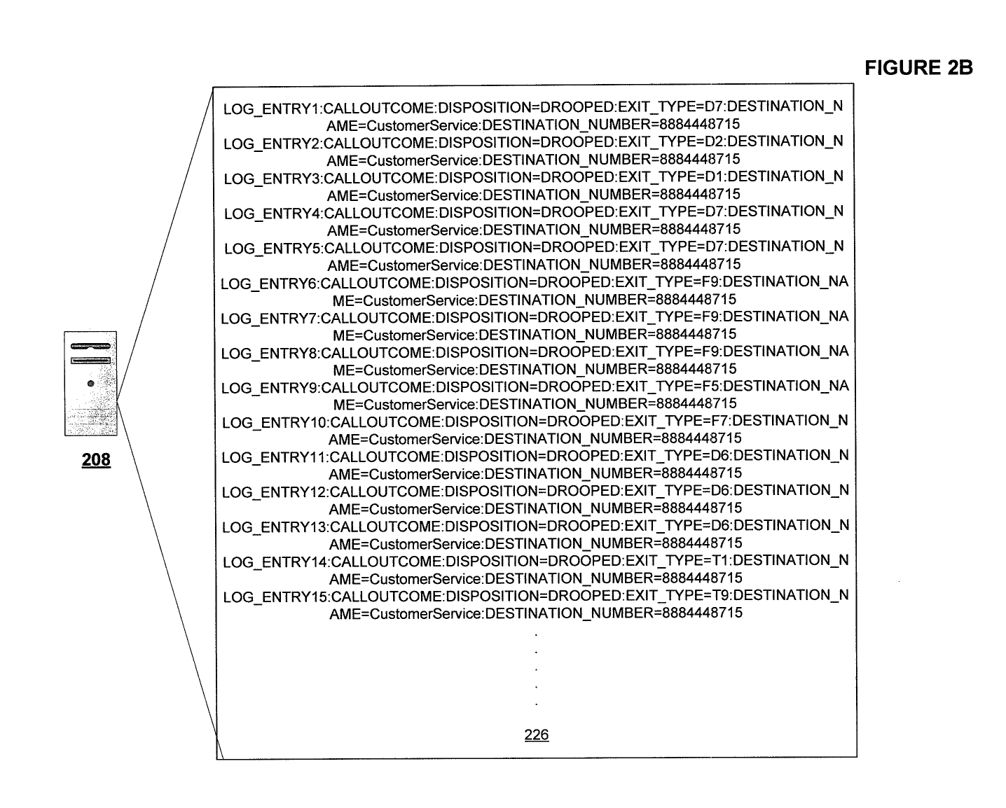

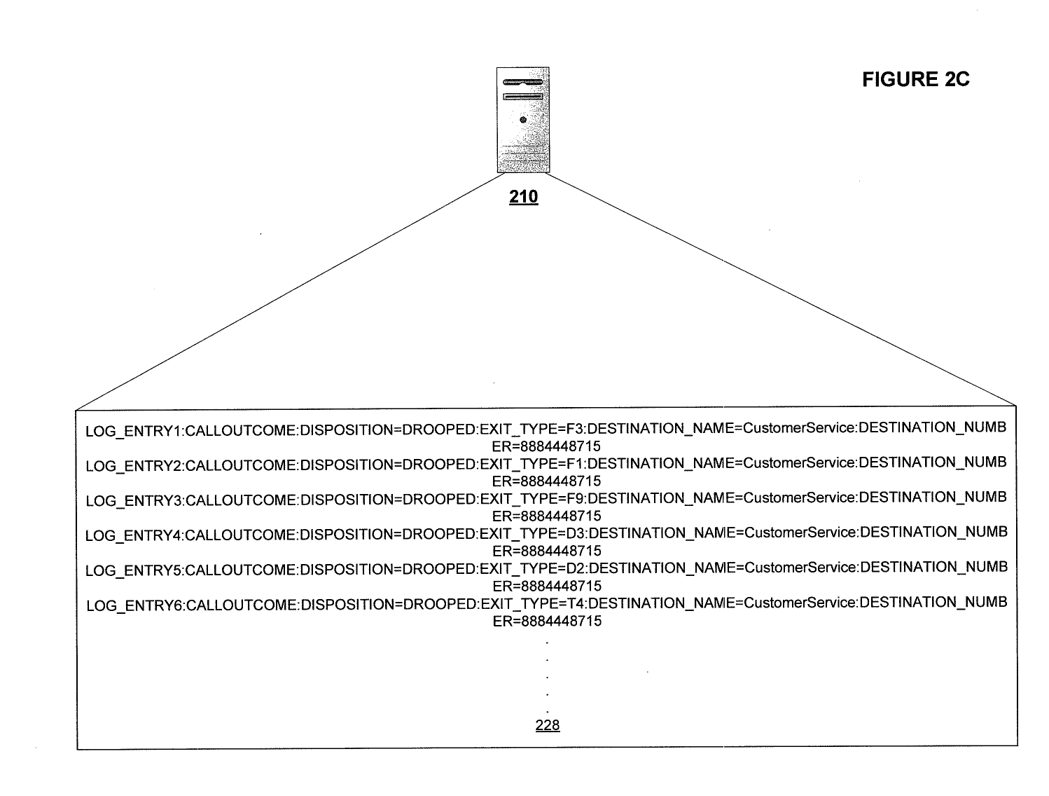

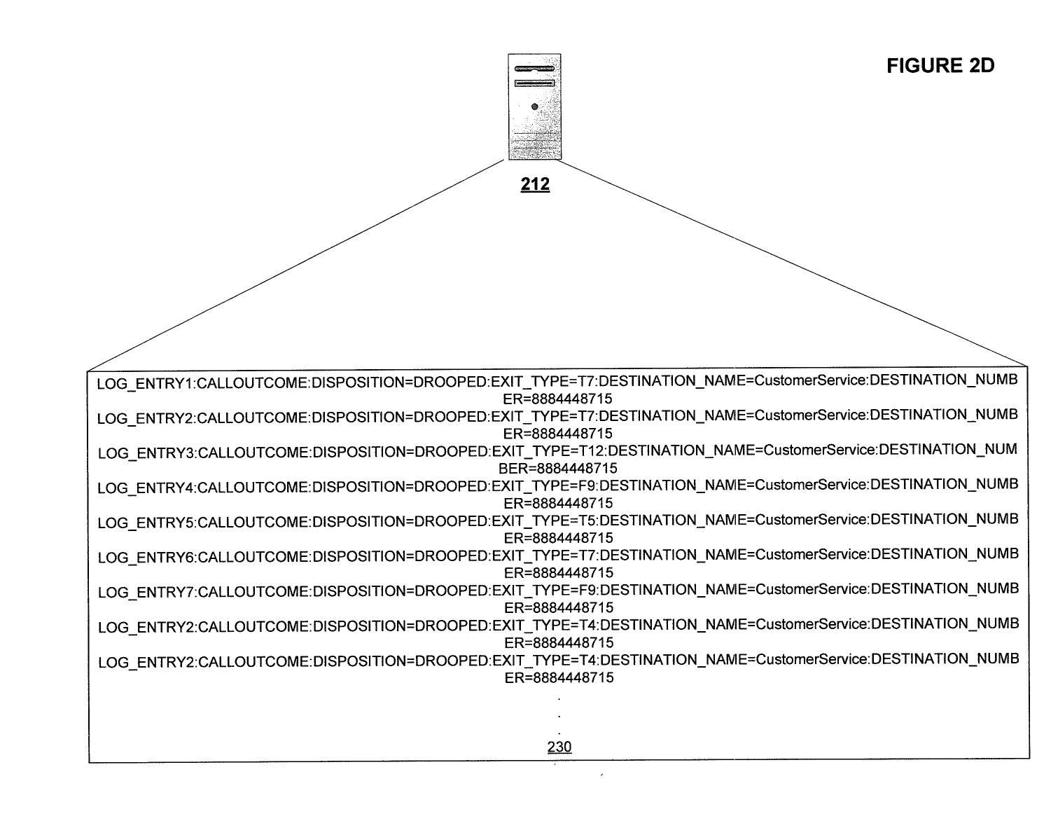

In FIG. 2, voice over internet protocol platform 200 receives calls from a number of callers 202a, 202b, 202c, 202d, 202e, 202f at load-balanced sites 204, 206 at geographically distributed locations. Each of the load-balanced sites 204, 206 has a number of servers 208, 210, 212, 214, 216 and 218 that receive calls over the Internet at an application layer port. Caller 202a and caller 202b are each serviced by server 208 at load-balanced site 204. Caller 202c is serviced by server 210 at load-balanced site 204. Caller 202d is serviced by server 212 at load-balanced site 204. Caller 202e and caller 202f are serviced by server 216 at load-balanced site 206. Each received call is handled by a single voice over internet protocol port established by a server processing the call. A monitoring tool at gateway servers 220, 222 obtain a metrics file from each server 208, 210, 212, 214, 216 and 218 at predetermined intervals. Alternatively, data from a metrics file for a particular server is transferred to the gateway servers 220, 222 when an alarm is generated. For example, the monitoring tool may display utilization for a particular server when an alarm is generated that indicates that the server is dropping over 14% of the calls. In one embodiment, an alarm is customizable by a client application. Metrics files obtained by gateway servers 220, 222 are parsed by the monitoring tool. In an exemplary embodiment, the monitoring tool displays the obtained information at a device 224 separate from the gateway servers 220, 222.

In FIG. 2B, an exemplary metrics file or call log 226 for server 208 is shown.

In FIG. 2C, an exemplary metrics file or call log 228 for server 210 is shown.

In FIG. 2D, an exemplary metrics file or call log 230 for server 212 is shown.

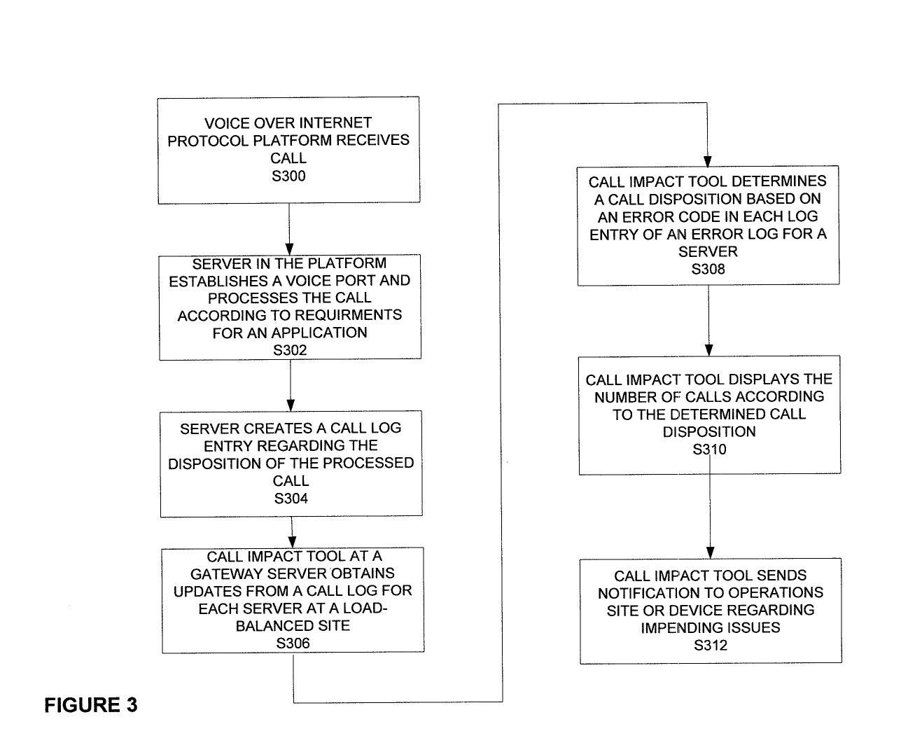

FIG. 3 begins with step S300 in which a voice over internet protocol platform receives a call at a site and a specified server, and over a specified voice over internet protocol port. In step S302, the server processes the call according to the requirements for a client application with which the call is associated. For example, a tele-voting application may require that a server plays three prerecorded messages and obtains a selection from the caller. The same server may also service calls for a customer service center, which may require the server to obtain a client identification number from the caller and retrieve a client file associated with the client identification number. The server processes the call and creates a call log entry regarding the disposition of the processed call in step S304 and stores the call log entry in a call log, or metrics file on the server. The call impact tool obtains real-time updates from a call log for each server processing calls at a site in step S306. In step S308, a call impact tool determines a call disposition based on an error code in each call log entry of a metrics file or call log for a server processing calls. In step S310, the number of calls having the same call disposition are displayed. In one embodiment, the display is a graphical user interface. In another embodiment, the number of calls having the same call disposition is displayed based on an application associated with the calls. In step 312, the call impact tool sends a notification to an operations site or a device regarding impending issues.

Each metrics file contains a line indicating the disposition of a call by exit code. Based on the exit code, a monitoring tool will determine how to display the disposition of the call. For example, a call may be indicated by the following entry in a metrics file for a server:

LOG_ENTRY:CallOutcome:Disposition=Dropped:Exit_Type=D7:Destination_Name=N urse:Destination_Number=8884448715. As shown in Table 1, each parameter in a log entry indicates information regarding the processing of the call indicated by the call log entry.

TABLE 1
Call Log Entry Parameters and Values

| Parameter | Definition | Comment or Example |
|---|---|---|
| Disposition | Final disposition of the call | Include Successful, |
| | | Dropped, or |
| | | FailedTransferred |
| Exit_Type | Unique code to indicate reason | e.g. “D-7” indicates a |
| | for call termination | malformed call request |
| Destination_Name | Brief description of destination | e.g. “CustomerService” for |
| | | a FailedTransferred |
| | | Disposition. |
| Destination_Number | If disposition is | Refers to a number or |
| | FailedTransferred then | extension to which the call |
| | <Destination_Number> contains | is transferred |
| | a transfer number | |

In one embodiment, an Exit_Type parameter is used in conjunction with Table 2 to determine classification of the call disposition.

TABLE 2
Possible Call Log Entry Values for the Disposition Parameter

| Disposition | Exit Type Format | Comment |
|---|---|---|
| Successful | T-* Any condition where a call | “*” is to be substituted by a |
| | was transferred due to a | unique number that will |
| | successful condition, not due to a | correlate to a specific |
| | failure. | condition as shown in |
| | H-* Condition where the call | Table 3 |
| | ended due to user hang up. | |
| | N-* Condition where the call | |
| | terminated due to a normal | |
| | condition. | |
| Dropped | D-* Any condition where a call | “*” is to be substituted by a |
| | was dropped. | unique number that will |
| | | correlate to a specific |
| | | condition as shown in |
| | | Table 3 |
| FailedTransferred | T-* Any condition where a call was | Does not include |
| | transferred due to a failure. | conditions where a call was |
| | | transferred due to normal |
| | | call function. “*” is to be |
| | | substituted by a unique |
| | | number that will correlate |
| | | to a specific condition as defined |
| | | by the application. |

In another embodiment, Table 3 is used to determine information associated with the particular error code indicated by the call log entry.

TABLE 3
Error Codes and Conditions for Call Dispositions

| Error Code | Error Condition |
|---|---|
| B | Blocked Calls |
| | (at a voice over internet protocol platform destination) |
| UA | Unanswered Calls |
| | (Unavailable resources at voice over internet protocol platform |
| | destination) |
| D | Dropped Calls (In-progress calls terminated prematurely after being |
| | answered) |
| D-1 | Platform redirector fails to recognize the incoming dialed number |
| | identification service |
| D-2 | Platform redirector could not find an application uniform resource locator |
| D-3 | Platform redirector timed out during the application fetch from the |
| | Content Server |
| D-4 | Platform application could not fetch audio file due to a Provisioning Error |
| | or a network file system resource being unavailable |
| D-5 | Platform application couldn't retrieve the announcement identification |
| | associated with the dialed number identification service |
| D-6 | Platform application could not retrieve application grammar due to |
| | “ASR/TTS resources unavailable” condition. |
| D-7 | Malformed call request |
| D-8 | Platform component failure during the call |
| D-9 | Caller hanging up (not considered a platform error) |

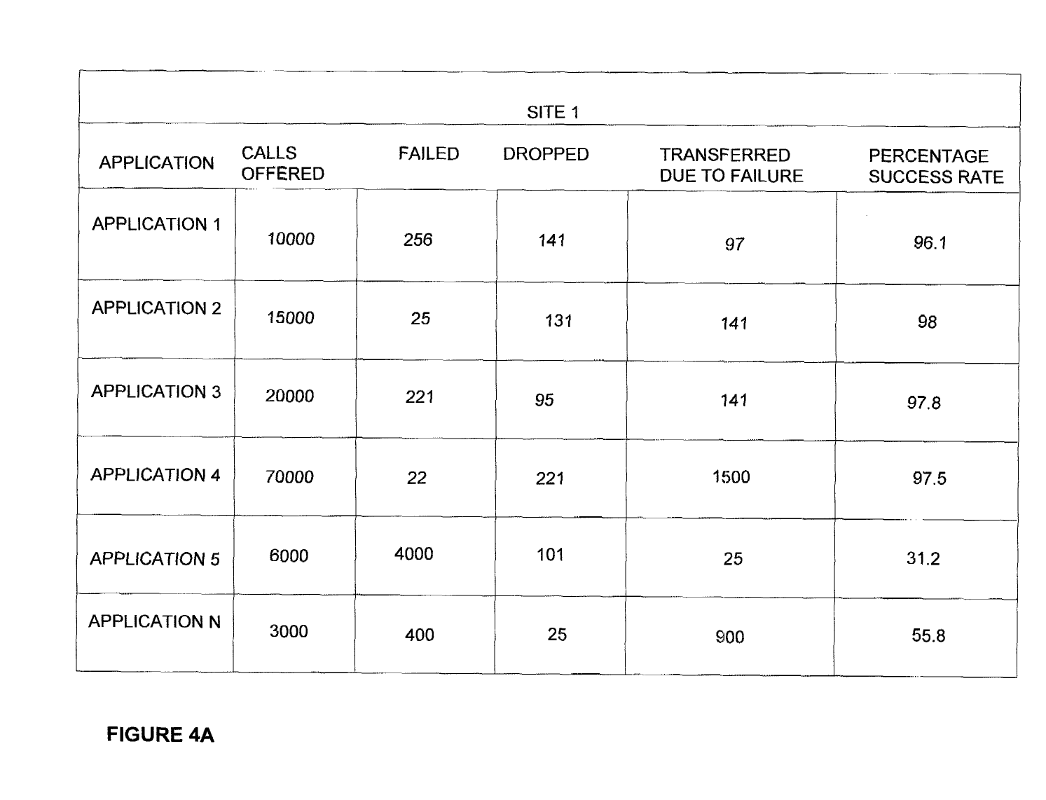

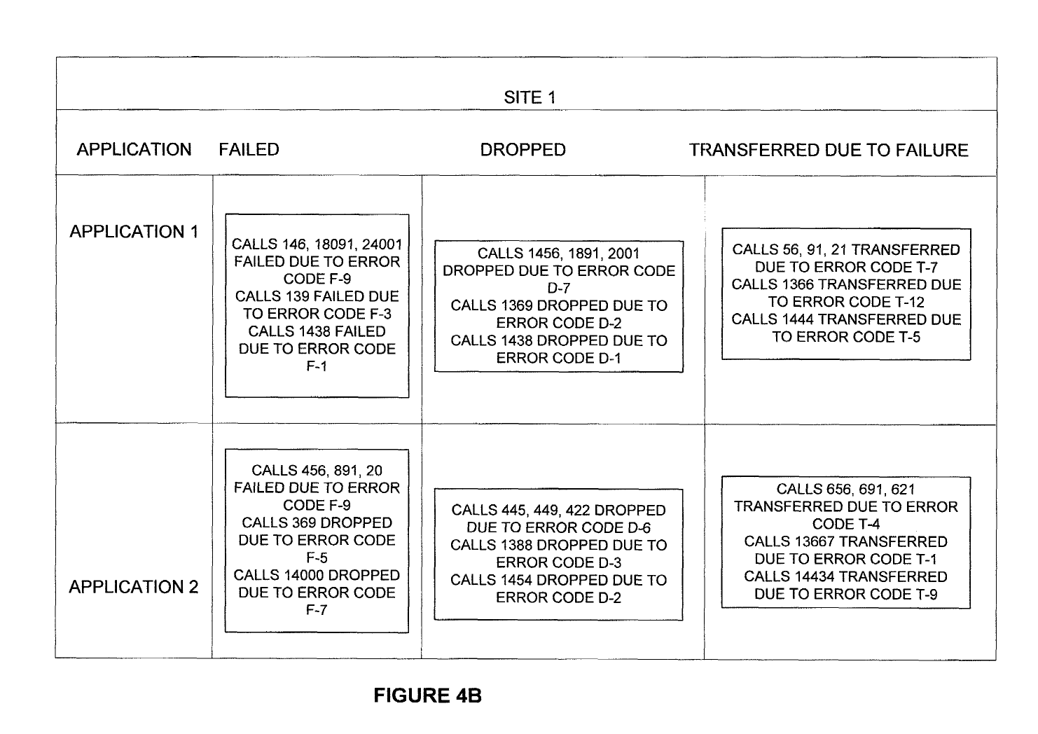

For example, the Disposition parameter in the exemplary call log entry is used in conjunction with Table 1 to determine that the disposition of the call is “Dropped”. In another embodiment, the Exit_Type parameter in the exemplary call log entry is used in conjunction with Table 2 to determine that the disposition of the call is “Dropped”. That is, it is determined whether the call is a failed call, dropped call, a call transferred due to failure, a successful call, or other call. Table 2 is used to determine that the “D” identifier in the error code “D-7” corresponds to a dropped call. Table 3 is used to determine the particular error condition associated with the call disposition and error code. For example, the exemplary call log entry indicates a dropped call due to error code “D-7”. Table 3 is used to determine the error condition that leads to exemplary error code “D-7”. Table 3 indicates that error code “D-7” corresponds to a malformed call request. In addition, error codes in Table 3 are used to determine an automated response that is played to a caller. In one embodiment, these error codes are standardized across the voice over internet protocol platform and each load-balanced site. As seen in FIG. 4A, the number of calls corresponding to each call disposition is displayed on the display tool. The particular impact to a particular client application (e.g., a tele-voting application), as differentiated by client application, is also shown. The number of calls offered and the percentage success rate is also shown as broken down by client application.

As shown in FIG. 4B, the number of calls failing due to a particular error condition, as evidenced by a particular error code, may be itemized along with the call disposition. In addition, the percentage of successful calls may also be shown. In FIG. 4B, the particular error code corresponding to the call disposition for each of the calls is shown. In one embodiment, an error condition is displayed as an alternative to, or in addition to the displayed error code.

In an exemplary embodiment, the call impact tool uses the following formula to calculate the percent success rate or percentage of successful calls terminated on the voice over internet protocol platform

Percentage Successful Calls=(x−y)/x*100 EQ. 1

where x=total number of calls terminated on the voice over internet protocol platform and y=total number of failed calls. That is, for each client application, the number of calls that are successfully processed and terminated is also shown on a display of calls that terminate unsuccessfully. In one embodiment, this information is aggregated for each of the client applications and displayed on a display.

Accordingly, the present invention enables a call impact determination tool that displays the calls exiting due to predefined error conditions based on a client application associated with the call. The method for monitoring call dispositions for a mass calling application at a voice over internet protocol platform includes receiving calls at the voice over internet protocol platform, processing each of the calls according to application-specific requirements for each call, and aggregating error information for each of the calls in categories based on call dispositions. Accordingly, aggregated information is displayed and categorized based on call dispositions for each application that provides services for the calls for which error information is aggregated.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, the call disposition information displayed is used by a user to reconfigure the load-balancing of servers, groups or sites. In this example, the user is an operations administrator. If a site is dropping more than a predetermined threshold of calls, or has a relatively low percentage success rate, as an example, calls will no longer be routed to the site. Rather, another server, group, or site having a greater percentage success rate will receive the call. As shown in FIG. 4A, calls for application 5 have a success rate of 31.2%. An operations administrator may subsequently diagnose issues associated with the application of application 1, for a mass calling application client.

In another embodiment, the display is accessible by a user of the voice over internet protocol platform. In this example, the user is a caller using a mass calling application service. The caller may access the display and make calling decisions based on call disposition information for the voice over internet protocol platform. For example, if the percentage success rate for call processing for a particular application is lower than a predetermined threshold, the caller may decide to wait until later to place a call.

In yet another embodiment, a user may be the business department of a client application serviced by the voice over internet protocol platform. The user may use the display to determine whether another client application has a better percentage success rate at a given site. The user may change business agreements based on the display of call disposition information.

In yet another embodiment, the display is a graphical user interface that is enabled to filter data to display requested items. A user of the display may enter input into a dialog box, drop-down menu, or other implementation of a selection tool selection criteria. For example, the user enters selection criteria including, but not limited to: applications having a percentage success rate over 40%, specified calls that were dropped and an associated error code, and sites receiving over 100,000 calls. It is noted that the selection criteria includes any information about the voice over internet protocol platform that is stored. One or more selection criteria may be entered by the user.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. For example, standards for Internet and other packed switched network transmission, as well as voice over internet protocol represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for monitoring call dispositions for a mass calling application at a voice over internet protocol platform, comprising:
receiving calls at the voice over internet protocol platform;
processing each of the calls according to application-specific requirements for each call;
aggregating error information for each of the calls in categories based on call dispositions; and
displaying the aggregated error information categorized based on call dispositions for each of a plurality of applications that provide services for the calls for which error information is aggregated.

2. The method according to claim 1,
wherein a display of the aggregated error information is updated in real-time.

3. The method according to claim 1,
wherein the call dispositions comprise one of: successful completion, dropped call, failed call and failed transferred call.

4. The method according to claim 1,
wherein the error information for each of the calls is obtained from call logs maintained by each of the plurality of servers at predetermined intervals.

5. The method according to claim 1,
wherein error information for each of the calls is obtained from a call log maintained by a server when the server raises an alarm.

6. The method according to claim 1, further comprising
determining error information for each of the calls based on codes from call log entries corresponding to each of the calls.

7. The method according to claim 1,
wherein a number of calls offered and a percentage success rate of offered calls is displayed for each of the plurality of applications.

8. The method according to claim 4,
wherein parameters for a call log entry stored in the call log comprise call disposition, exit type, destination name and destination number.

9. The method according to claim 1,
wherein display information for the aggregated error information is provided to a device.

10. The method according to 9,
wherein the device comprises a mobile device.

11. The method according to claim 9,
wherein a notification is sent to the device via at least one of: text message, webpage, email, automated phone call and facsimile.

12. The method according to claim 11,
wherein the notification comprises information associated with the aggregated error information.

13. A system for monitoring call disposition for a mass calling operation at a voice over internet protocol platform, comprising:
at least one server operable to receive calls;
at least one processor operable to process each of the calls according to application-specific requirements for each call;
an aggregator operable to aggregate error information for each of the calls in categories based on call dispositions; and
a second processor operable to display the aggregated error information categorized based on call dispositions for each of a plurality of applications that provide services for the calls for which error information is aggregated.

14. The system according to claim 13,
wherein the plurality of applications are serviced by the voice over internet protocol platform.

15. A tangible computer readable medium storing a computer program, recorded on the computer readable medium, for monitoring call disposition in a mass calling operation at a voice over internet protocol platform, comprising:
a receiving code, recorded on the tangible computer readable medium, executable to receive calls at the voice over internet protocol platform;
a first processing code, recorded on the tangible computer readable medium, executable to process each of the calls according to application-specific requirements for each call;
an aggregating code, recorded on the tangible computer readable medium, executable to aggregate error information for each of the calls in categories based on call dispositions; and
a displaying code, recorded on the tangible computer readable medium, executable to display the aggregated error information categorized based on call dispositions for each of a plurality of applications that provide services for the calls for which error information is aggregated.

16. The tangible computer readable medium according to claim 15,
wherein a number of calls failing due to a predetermined error code is displayed along with call dispositions for the calls.

17. The tangible computer readable medium according to claim 16,
wherein the predetermined error code corresponds to a predetermined error condition.

18. The tangible computer readable medium according to claim 17,
wherein the predetermined error condition comprises at least one of: a blocked call, an unanswered call, a dropped call, a platform redirector error, a platform application error, a malformed call request, a platform component failure and a caller hanging up.

19. The tangible computer readable medium according to claim 18,
wherein the platform redirector error comprises at least one of: failure to recognize an incoming dialed number identification service, inability to find an application uniform resource locator and a timeout during an application fetch from a content server.

20. The tangible computer readable medium according to claim 18,
wherein the platform application error comprises at least one of: inability to fetch audio files due to a provisioning error, inability to fetch audio files due to a network file system resource being unavailable, inability to retrieve an announcement identification associated with a dialed number identification service, and inability to retrieve an application-specific grammar.
